(19) United States
(12) Patent Application Publication
(10) Pub. No.: US 2024/0184693 A1
(43) Pub. Date: Jun. 6, 2024

(54) UNSUPERVISED METHOD FOR MULTIVARIATE MONITORING OF AN INSTALLATION

(71) Applicant: IPPON INNOVATION, TOULOUSE (FR)

(72) Inventors: François BERGERET, TOULOUSE (FR); Amaury ALVES, TOULOUSE (FR); Aurore ARCHIMBAUD, TOULOUSE (FR); Carole SOUAL, TOULOUSE (FR)

(21) Appl. No.: 18/394,571

(22) Filed: Dec. 22, 2023

Related U.S. Application Data
(63) Continuation-in-part of application No. 17/784,190, filed on Jun. 10, 2022, now abandoned.

(30) Foreign Application Priority Data
Jul. 9, 2020 (FR) 2007300

(51) Int. Cl. G06F 11/36; G06F 11/32

(52) U.S. Cl. CPC G06F 11/3688; G06F 11/327

(57) ABSTRACT

A method for an unsupervised monitoring an installation including sensors measuring monitored variables of an operation of the installation and delivering signals proportional to the monitored variables to a monitoring system. A plurality of N test runs is performed. The signals delivered by the sensors for each test run are collected and stored. A scalar dissimilarity index for each curve associated with a test run and a sensor is computed by comparing with all the other N-1 curves associated with a test run. The dissimilarity indexes of the curves and a multivariate distance over the dissimilarity indexes of the text runs are compared to a threshold. An alarm is generated if the threshold is overpassed.

### RELATED APPLICATION

This application is a continuation-in-part of U.S. application Ser. No. 17/784,190 filed on Jun. 10, 2022, which is a § 371 application of PCT/FR2021/051273 filed Jul. 8, 2021, which claims priority from French Patent Application No 2007300 filed Jul. 9, 2020, each of which is incorporated herein by reference in its entirety.

### FIELD OF INVENTION

The present invention belongs to the field of monitoring an installation through the use of a variety of sensors.

The installation may be of any type but comprising at least one sensor for measuring and internal or an external variable either reflecting the installation operation or an environmental condition of the monitored installation. The invention is based on a multivariate identification of an atypical behavior of at least one variable measured by a sensor during a plurality of test runs. Such an atypical behavior is detected by analyzing a response curve of the variable measured by the sensor, although such a response, i.e. the shape of the curve is unknown before hand. Therefore, the monitoring may be performed unsupervised without prior knowledge of the application operation.

Although being very versatile in the technical field of applications and being able to detect an abnormal behavior without prior knowledge of an expected response, the implementation of the invention requires limited computing power and therefore limited energy consumption.

The invention is particularly useful for the monitoring of a process like an industrial manufacturing process, in the field of metrology, or for comparing a series of test runs, like in a flight test, involving a plurality of sensors, the expected response of which, or at least for a part of them, is not known before hand.

Because of these advantages, the invention may also be applied to wellness or fitness wearable devices. The application encompasses any type of sensors, like pressure, speed, flow rate, temperature, light, electrical variables or images without this list being in anyway exhaustive, and any combination responses of such sensors, and is applicable to any shape of response curve and any numbers of sensors whether of the same types or of different types.

Being multivariate the application may be used to detect an abnormal; behavior of one or multiple variables taken individually or may be used to detect an abnormal behavior of a test run compared to others over the responses of all the measured variables, that is to say each variable may only slightly deviate from a steady state or nominal behavior, but the combined behavior may reveal an atypicality.

### BACKGROUND OF THE INVENTION

The processing of curves, also called functional data, has existed for several years. However, the identification of an abnormal curve is generally univariate, that is to say, the existing methods work mainly sensor by sensor and seek to detect an atypical curve for a given sensor.

In the case where there are several sensors, these are not multivariate methods because each sensor is processed separately without taking into account the correlations between sensors. However, it is common that a curve is not atypical in a univariate manner.

This type of behavior is called by the person skilled in the art “atypical curve due to a multivariate phenomenon”. It is understood herein that it is particularly interesting to be able to identify this type of behavior.

For five years, new multivariate detection methods for functional data have been proposed in the literature. They are mainly based on two major approaches.

The most commonly used consists in “reducing” the curves via different techniques, for a given sensor. More specifically, the initial curve, which is characterized by several hundreds or thousands of points, is transformed into a set of coefficients by projection methods (such as B-splines, Fourier basis, wavelets, etc.). The idea is then to select a subset of these coefficients to keep only the relevant signal and remove the noise. The subsets of coefficients obtained for each of the sensors are concatenated and it is then possible to use conventional statistical techniques to detect atypicals on these reduced curves.

However, this approach raises many issues. First of all, the choice of the projection method often depends on the type of functional data (periodic or not, for example) and is therefore often based on a priori knowledge, which makes the method little generalizable. Furthermore, the selection of the coefficients is a very sensitive step in the context of the detection of atypicals, because if the thresholding is too “hard”, a portion of the signal can be lost and the information on the atypical behavior also.

A simple method also consists in summarizing the curve by one or more simple statistical indices (average, standard deviation, etc.) but the loss of information is then very significant. On the contrary, if all coefficients are kept, no information is lost, but cannot get rid of the noise and it is possible to be in a situation where more coefficients than curves are obtained, an undesirable situation in Statistics.

Another approach consists in trying to directly calculate an index which measures the atypical behavior of a curve resulting from the notion of depth to the majority of the data. The more a curve has a significant depth value, the more it has a behavior similar to the majority of the data. The main drawback to this approach is the complexity of the calculations, which makes it difficult to use on real datasets when the number of sensors increases, even to about ten sensors.

### SUMMARY OF THE INVENTION

The invention aims at solving the shortcomings of the prior art and to this end pertains to a method for an unsupervised monitoring an installation comprising at least one sensor measuring a monitored variable of an operation of the installation and delivering a signal proportional to the monitored variable to a monitoring system comprising a computer with a non-transient memory configured to trigger a test run and to acquire the signal delivered by the at least one sensor during the test run, further comprising a computer program configured to store an acquired signals in the non-transient memory and to process a plurality of signals stored in the non-transient memory, comprising the steps of:
triggering a plurality of N test runs, with N higher or equal to 3, each test run of the plurality having a same duration and a same number of datapoints;
storing in the non-transient memory the signal delivered by the at least one sensor for each test run in the form of a succession of datapoints, each datapoint corresponding to a level of the monitored variable at an acquisition variable value, the succession of datapoints defining a curve associated with a test run and the at least one sensor for a total of N curves;
computing a scalar dissimilarity index for each curve associated with a test run and the at least one sensor by a comparison with all the other N-1 curves associated with a test run and with the at least one sensor of the plurality of N test runs;
obtaining a threshold of the scalar dissimilarity index; and
generating an alarm if the scalar dissimilarity index of a curve associated with a test run of the plurality of N test runs overpasses the threshold of the scalar dissimilarity index.

Thus, the method of the invention does not rely on a prior knowledge of the shape of the response curve to detect an atypicality. The system may therefore monitor any kind of installation in an unsupervised manner.

The invention may be implemented according to the specific embodiments and variants disclosed hereafter which may be considered individually or according to any operative combination.

According to a first embodiment, the comparison comprises for each curve, computing quadratic distances for each datapoint of the curve relative to the N-1 datapoints of the other curves at the same acquisition variable value, computing a sum of the quadratic distances with the other curves for each acquisition variable value, the dissimilarity index for a curve being the root mean square of the distances with the other N-1 curves.

Such a method called RMSE is efficient in computing power and thus in energy consumption as well as computational time and may be applied to a wide variety of installations from production monitoring to fitness wearables.

According to a second embodiment, the comparison comprises computing a scalar correlation coefficient of each curve with each of the N-1 curves, the dissimilarity index of a curve being the mean value of the N-1 scalar correlation coefficient of the curve with the N-1 other curves.

This second embodiment, which can be combined with the first embodiment, may be better suited for some specific applications.

The acquisition variable may be selected among time, distance and frequency. Although non limiting, these are the most common acquisition variables, i.e. independent variables, a monitored variable, i.e. dependent variable, may be a function of.

The monitored variable may be selected among, pressure, force, strains, acceleration, speed, distance, voltage, intensity, electrical impedance, power, energy, temperature, flowrate, luminance, chrominance, reflectance, concentration and radioactivity.

The threshold of the scalar dissimilarity index may be obtained from a database configured to be accessed by the computer.

Alternatively, or in combination, the method may comprise the steps of:
storing the dissimilarity index computed for each test run in the non-transient memory;
retrieving a subset of n dissimilarity indexes with n≤N from the non-transient memory and computing a central value M and a spreading S of the scalar dissimilarity index over the subset; and
obtaining the threshold of the scalar dissimilarity index by M±X.S with X≥1.

This embodiment enables a dynamic threshold to be defined in an unsupervised manner.

Advantageously, the method may comprise obtaining multiple threshold levels for different values of X and wherein a different alarm is generated depending on the overpassed threshold level.

According to an embodiment the central value M is a mean value.

According to another embodiment the central value M is a median.

According to variants the spreading value may be a standard deviation or a quartile.

According to an advantageous embodiment the installation may comprise at least a second sensor and further comprising the steps of:
for the N test runs storing the signal delivered by the at least second sensor for each test run in the form of a succession of datapoints, each datapoint corresponding to a level of a second monitored variable at a second acquisition variable value, the succession of datapoints defining a curve associated with a test run and the at least second sensor for a total of N curves;
computing a scalar dissimilarity index for each curve associated with a test run and the at least second sensor by a comparison with all the other N-1 curves associated with a test run and with the at least second sensor of the plurality of N test runs;
computing a scalar multivariate difference index for each test run of the plurality of N test runs by a multivariate distance from one test run to another based on the dissimilarity indexes of the N curves associated with the at least one sensor and the N curves associated with the at least second sensor; and
obtaining a threshold for the multivariate difference index; and
generating an alarm if the scalar multivariate difference index of a test run of the plurality of N test runs overpasses the threshold of the scalar multivariate difference index.

This embodiment enables us to compare two or more test runs on a multivariate basis while still requiring reduced computing power.

According to a specific embodiment the scalar multivariate difference index may be a Malahanobis distance.

According to another embodiment the scalar multivariate difference index is computed according to a projection pursuits method.

### BRIEF DESCRIPTION OF THE DRAWINGS

The invention may be implemented according to the preferred embodiments, in no way limiting, and described hereafter with reference to FIGS. 1 to 6 in which:

FIG. 1 is a flowchart of an exemplary embodiment of the method;

FIG. 2 is a table showcasing the computations performed on a monitored variable over 3 test runs to calculate a dissimilarity index according to a RMSE method;

FIG. 3 illustrates the curves corresponding to the 3 test runs of FIG. 2;

FIG. 4 is an exemplary embodiment of curves showing a monitored variable variation as a function of an acquisition variable over multiple test runs;

FIG. 5 shows an exemplary embodiment of the curves obtained on a second sensor during the 3 test runs of FIG. 2 and FIG. 3 as well as a table summarizing a computation of a dissimilarity index for these 3 curves according to the RMSE method; and

FIG. 6 is a schematic presentation of an installation implementing the method.

### DETAILED DESCRIPTION OF EMBODIMENTS

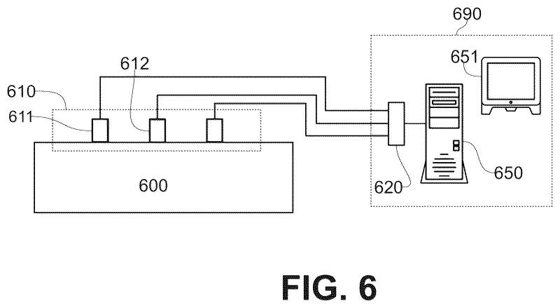

FIG. 6, in an exemplary embodiment an installation (600) is monitored by a plurality of sensors (610). Without limitation, the installation may be a manufacturing process where several parameters need to be monitored, or quality features of manufactured products may be measured by such sensors, it may be a flight test where sensors are measuring physical characteristics of a structure or of an environment, it may also be a space, monitored by one or several cameras.

Other applications comprise distant acquisition (telemetry) of running variables for satellites or aircrafts, also radar and sonar applications as well as ultrasonic testing.

Each sensor of the plurality (610) measures at least one characteristic of the installation during test runs. The characteristic measured by a sensor (611, 612) may be a single physical characteristic such as pressure, force, temperature, humidity, speed, distance, flowrate, current intensity, voltage, impedance, acceleration, luminance, chrominance, reflectance, luminosity or radioactivity. The measured characteristic may also result from an acquisition involving an array of sensors such as in a video image. The set of sensors may be of the same type, e.g. when measuring pressure along a duct line or maybe of different types.

The nature of each sensor may also be different in terms of measurement technology although measuring the same type of variable. For example, in a set of pressure sensors, there may be sensors based on strain gauges, and/or capacitive pressure sensors, and/or piezoresistive pressure sensors, and/or resonant pressure sensors.

Each sensor of the plurality (610) delivers an output that is proportional to a level of a monitored variable, the delivered output may be analogic, e.g., a voltage variation reflecting the physical characteristic variation, or digital.

The output is directed to an adapted acquisition board (620) configured to condition the signal in a suitable way for a computer acquisition by a monitoring system (690).

The monitoring system (690) comprises a computer (650) comprising a non-transient memory, a hard drive, and at least one computer program for triggering an acquisition of the signals delivered by the acquisition board (620) during a test run over a given time, storing the acquired signals in the memory means, processing these signals when required, like through a filtering or the performance of a Fourier transform, and analyzing the processed signals by the of methods described hereafter. The monitoring system may also comprise a display (651) and means to generate and send information about the installation (600) performance including different levels of alarm depending on a result of signal analysis.

The monitoring system (690) may be hard wire connected to the installation, it may also be connected by wireless connection such as WiFi®, Bluetooth®, be remote and connected through a LAN, a W PAN or World Wide Web, or through a communication network from 1G to 5G, LoRa® or Sigfox®, or a satellite link, or any operative combination.

The computer program may be comprised in a readable medium such as the hard drive of the computer, a removable hard drive, a CD/DVD ROM, or an USB stick, or may be downloaded in the computer memory from a remote server through a network, be executed, or partly executed, on a remote server connected via a network to the computer (650) of the monitoring system (690).

During each test run a set of characteristics is acquired from the sensors.

A test run comprises an acquisition from each sensor of a plurality of measurement points each point corresponding to a level of a variable measured by the sensor at a given time date between the starting time and the ending time of the test run. Thus, at the end of a test run, a data curve, called curve, representing for instance the level of the measured variable v time is obtained.

According to this example the curve is temporal but the person skilled in the art understands that it is not a limitation and that a curve actually represents the evolution of a variable as a function of another information, said information may, for instance, be the time, the frequency, another variable or combination thereof, like a distance traveled and from an overall point of view the level of the variable measured by the sensor and acquired by the monitoring system is the monitored variable and the curve represents the evolution of the monitored variable according to an acquisition variable.

The duration of a test run depends on the monitored installation, it may be a fraction of a second up to weeks or months, and so is the acquisition frequency. T is the time duration of a test run, the acquisition frequency shall be at least 2/T in order to have at least 2 datapoints per curve, more likely the acquisition frequency shall be higher than 2/T.

The shape of the curve is unknown a priori. For the method to work the monitored variable shall be a function of the acquisition variable, although the mathematical relation between the two is unknown and does not need to be known or assessed, that is, in a single curve, only one value of the monitored variable shall correspond to one value of the acquisition variable.

A test run may be defined by a time duration and an acquisition frequency, or a number of datapoints acquired during this duration, that may be the same for a same monitored variable in each of the test runs on which the method is applied, though two different monitored variables, corresponding to a first and a second sensor, may be functions of different acquisition variable, and may not exhibit the same number of datapoints for each acquisition, the curves corresponding to the first monitored variable shall have the same number of datapoints in all the compared test runs, as well as the curves of the second monitored variable shall have the same number of datapoints in all the compared test runs, although this number of datapoints may be different from the number of datapoints in the first monitored variable curves.

The aim of the invention is to detect at least one or more monitored variable of the installation that exhibits an abnormal behavior, that is, the curve associated with this monitored variable during a test run significantly deviates from a steady state situation wherein the curve corresponding to this steady state situation is unknown a priori.

Such a curve depicting an abnormal behavior is called an atypical curve.

An atypical curve delivered by a sensor may mean that the behavior of the monitored variable deviates from steady state conditions, thus, that the monitored process may be dysfunctional, it may also mean that the sensor delivering the signal is dysfunctional.

From an overall point of view an atypical curve is a sign of an appearance of an unforeseen event or a non-conformity.

To this end the method relies on a plurality of test runs. Depending on the installation and the monitored behavior, a test run may be triggered at defined time intervals, randomly or by a specific event coming either form the installation itself or by an external event, e.g. by an operator, as an example in case of a flight test, by a specific maneuver.

Also, the method may comprise a continuous acquisition of a monitored variable, a test run being defined by subsets of this acquisition corresponding to the same duration or to a same number of datapoints.

For the method to work, the test run should be conducted at least twice but from a practical point of view it is repeated multiple times during the monitoring process, or during the execution of the specific maneuver in the same flight or in different flights in the preceding example.

As shown below an atypical curve is detected by a comparison of at least one curve obtained during a test run from a sensor with other curves obtained from the same sensor during other test runs.

When applied to only two test runs, the method will detect a difference in the two curves but cannot define which of these two curves is atypical, a dissimilarity index computed according to any of the embodiments being the same for each of the two curves. Therefore, detecting an atypical curve when there are only two curves being different to each other requires that one of the two curves is defined as a reference curve, the other being thus atypical.

Such a situation is specific and from an overall point of view, the method is applied considering N curves, i.e. N test runs, with N>3, and therefore does not need such a reference curve to be defined.

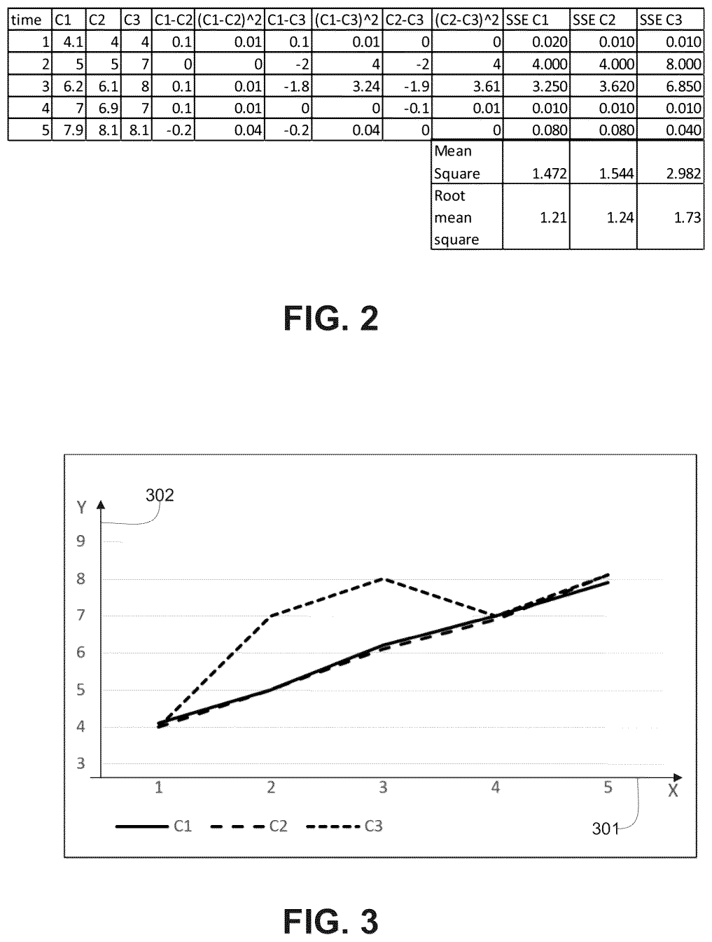

FIG. 3 according to a simplified exemplary embodiment, 3 tests runs are conducted and for a given first sensor (611 FIG. 6) each test run delivers a different curve (C1, C2, C3). A curve is a succession of points giving each point corresponding to a level of the monitored variable (302—Y axis) at a given value of the acquisition variable (310—X axis). The corresponding values of the monitored variables for each test run are given in column 2 to 4 for each value of the acquisition variable in column 1 of the table of FIG. 2.

In this example the test run duration is e.g. 5 seconds and the acquisitions frequency is 5/5=1 Hz.

The order in which the test runs are conducted is not relevant for the application of the method, the test run corresponding to curve C3 may have been conducted before the test run corresponding to curve C1.

Although the monitored variable values for each test run are given for a same value of the acquisition variable, if the acquisition variable is time, it shall be understood that each curve corresponds to a different test run performed at different dates but during the same time lapse and at the same acquisition frequency, therefore, the time dates given in the first column are relative to the starting date of each test run.

According to the first embodiment, each curve is compared point by point, i.e. for each point at the same value of the acquisition variable (301) in the other curves. In this exemplary embodiment of the method, called RMSE (Root Mean Square Error), a square distance on the Y axis (302) is calculated for each point of a curve relative to each point at the same acquisition variable of the other curves as shown in columns 6, 8 and 10 of the table FIG. 2. Error actually means deviation.

Then, as shown in the last 3 columns, the sum of the square distances of the points of each curve relative to the others is computed, which in this example, is given e.g. for curve C1 for each point by SSE C1=(C131 C2)\hat{ }2+(C1−C3)\hat{ }2 and for curve C2 SSE C2=(C1−C2)\hat{ }2+(C2−C3)\hat{ }2.

A dissimilarity index may then be calculated for each curve by taking the root mean square of the quadratic distances with the other curves over the same spanning of the acquisition variable (301).

In this example the dissimilarity indexes for the 3 curves C1, C2 and C3 are:
C1: 1.21
C2: 1.24
C3: 1.73

It follows that curve C3, exhibiting the highest dissimilarity index of the three, is the most dissimilar in this example.

Thus, this method which requires small computing power allows to detect a dissimilar or atypical curve, in this case C3, and to quantify the dissimilarity by a single scalar value, called a dissimilarity index.

When a dissimilarity index of one or several curves overpasses a given threshold, the monitoring system may trigger an alarm or a warning or take further action depending on the monitored installation.

The RMSE method is generalized as follow:
N: number of test runs
P: number of monitored variables (sensors)
D is the number of datapoints of the curves of a sensor
Cₖ=(Y_{1,k} . . . Y_{D,k}) where Y_{i,k} is the level of the monitored variable for the i^{th} datapoint in test run/curve k

```
for j=1 to P
  for i=1 to N
    for k=1 to N with k≠ i
      for j= 1 to D
        compute Σₖ(Y_{j,i} − Y_{j,k})² (sum of squares)
      end
    end
    Compute RMSE
  end
end.
```

This method enables, with little computing power, to detect and to quantify an abnormal behavior in the output of one or multiple sensors without prior knowledge of the shape of the response curves. The example is given in the time domain but is applicable in any kind of curve after a preliminary processing of the data, e.g. a Fourier transform to be in the frequency domain or, for instance, on Pressure v Temperature curves, in this later case the point of each of the corresponding signals are preferably acquired at the same time but may also be interpolated by known retiming techniques.

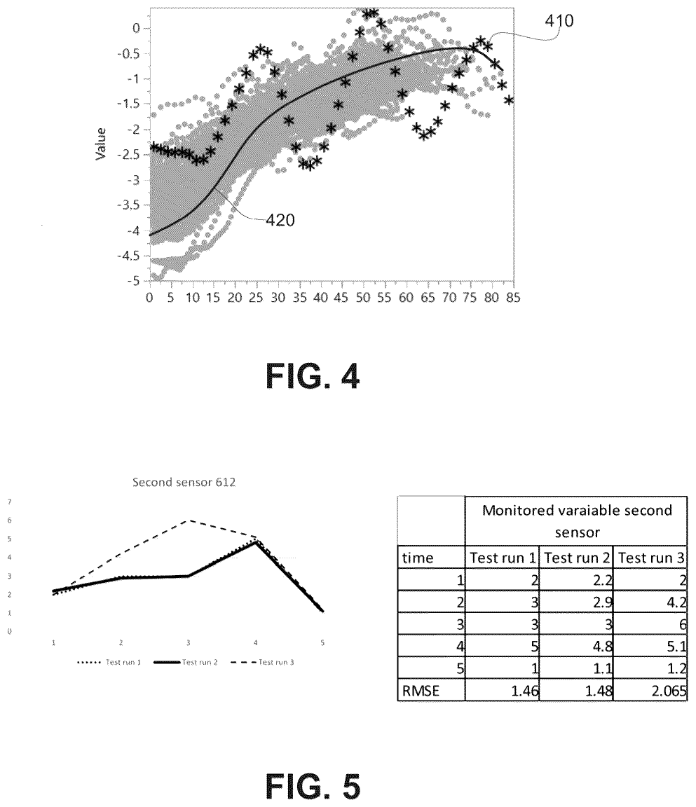

FIG. 4 according to another exemplary embodiment, multiple tests runs are conducted leading to multiple curves. Assuming, for illustrative purpose only, that these multiple curves, for the great majority of them, exhibit an average shape (420) as depicted, and that a specific curve (410 in star points) exhibits a behavior that in this figure appears to significantly deviate from the average behavior, in such a case, because the values of the points of this specific curve (410) are laying among the overall spreading of the multiple curves, the RMSE method may lead to the calculation of a dissimilarity index that may not differentiate enough this curve although it exhibits a singular behavior and therefore is atypical.

According to a second embodiment of the method, called Correlation Method, a dissimilarity index may be obtained by computing a correlation coefficient of each curve with the other curves.

The correlation coefficient is obtained by any method known in the art, such as the Bravais-Pearson method, the Spearman coefficient method, etc.

A correlation coefficient takes a scalar value comprised between −1 and +1. +1 represents a strong correlation, −1 a strong anti-correlation, i.e. the values of each curve change in opposite direction, and a poor correlation leads to values close to 0.

As the curves are connected to a single sensor measuring the same monitored variable over different test runs, a correlation coefficient of −1 will usually depict a strongly atypical curve.

More specifically, for a given sensor, over a set of N curves, for each curve, the method computes N-1 correlation coefficients.

A mean value of the N-1 correlation coefficients is then calculated for each curve, and this mean value is assigned to each curve as a dissimilarity index of this curve. Therefore, in this embodiment, the lower the dissymmetry index the more atypical the curve.

If the dissimilarity index of one or several curves becomes lower than a defined threshold, the monitoring system may generate an alarm or a warning or take further action.

Form a generalized point of view the method of this second embodiment may be described as follow: with N the number of curves and P the number of sensors:

```
for j=1 to P
    for i=1 to N
      for k=1 to N with k≠ i
        Compute corr(Cᵢ, Cₖ) i≠ k (Ci : i^{th} curve)
      end
  Compute c̅o̅r̅r̅(̅C̅ₗ̅)̅
    end
end
```

Like for the RMSE method this second embodiment does not require a prior knowledge of the shape of the curves and therefore enables an unsupervised detection of an abnormal or deviating behavior.

Compared to the RMSE method, the higher the correlation coefficient (closer to 1) the lower the atypicality. In order to have a similar variation as RMSE the dissimilarity index may be computed, for instance, as:

$$\frac{1}{\overline{corr ( {C}_{l} )}} \qquad [ Equation 1 ]$$

The selection of the method to be applied depends on the installation. Also, the RMSE method may be applied to a subset of sensors of an installation and the Correlation Method to another subset of sensors of the same installation or the two methods may be applied to all the sensors in sequence and a composite dissimilarity index I calculated, for each curve, using for example Equation 2:

$$I = \frac{{k}_{1} RMSE}{{k}_{2} \overline{corr ( {C}_{l} )}} \qquad [ Equation 2 ]$$

Where k₁ and k₂ are scalar coefficients. Or any other combination.

The embodiments exposed hereinabove enable to detect an atypical behavior of a monitored variable delivered by a single sensor along the performance of a plurality of test runs. An atypical behavior may appear on a set of sensors, i.e., on different monitored variables, but according to the method exposed so far, such atypical behaviors are detected individually on each monitored variable/sensor.

However, there may be cases where two test runs may differ only slightly from each other if the monitored variables are considered individually but where such a slight difference is being observed all over the monitored variables therefore depicting a stronger deviation from steady state conditions then what could be concluded from the monitored variables taken individually.

Therefore, there is a need for a multivariate assessment of dissimilarity or difference between two test runs.

FIG. 5 shows an example of 3 acquisitions performed on a second sensor (612) of an installation during the same 3 test runs as in FIG. 3. In this non limiting example the value of the monitored variable is shown according to an acquisition variable which is time as in FIG. 3, however it is not a pre-requisite that the two sensors/monitored variables be acquired according to the same acquisition variable.

The monitored variables corresponding to each different sensor may be acquired according to a different acquisition variable and with a different number of datapoints, e.g. a single curve delivered by the first sensor may comprise 100 datapoints per tests run giving the first monitored variables according to a first acquisition variable, for instance time, while a single curve delivered by a second sensor may comprise 50 datapoints per test run, giving the second monitored variable according to a second acquisition variable, for instance a travelled distance.

Since the dissimilarity index is computed for each monitored variable/sensor by comparing the curves corresponding to this monitored variable over the plurality of test runs, it is mandatory that for a same monitored variable/sensor according to a same acquisition variable, all the corresponding curves have the same number of datapoints over all the considered test runs. However, since the computed dissimilarity index is a scalar value for each test run, it is an advantage of the method that computing a multivariate difference index to compare test runs does not require that each sensor be acquired according to the same frequency or space of acquisition.

The table in FIG. 5 shows the dissimilarity indexes for each test run corresponding to the monitored variable of the second sensor. Applying this method to multiple sensors and multiple test runs gives a table similar to Table 1 hereunder:

TABLE 1

| | RMSE | RMSE | | RMSE |
|---|---|---|---|---|
| Test | variable/ | variable/ | | variable/ |
| runs | sensor #1 | sensor #2 | . . . | sensor # P |
| #1 | 1.21 | 1.46 | . . . | RMSE(test run |
| | | | | 1, Variable P) |
| #2 | 1.24 | 1.48 | . . . | RMSE(test run |
| | | | | 2, Variable P) |
| #3 | 1.73 | 2.06 | . . . | RMSE(test run |
| | | | | 3, Variable P) |
| . | . | . | . | . |
| . | . | . | . | . |
| . | . | . | . | . |
| # N | RMSE(test run | RMSE(test run | . . . | RMSE(test run |
| | N, variable 1) | N, variable 2) | | N, Variable P) |

Table 1 is a N×P matrix with the columns being the monitored variables and the lines being the test runs. Such a matrix may be used to compute a multivariate difference index by using known methods such as the Malahanobis distance, or the projection pursuits method, the latter being better suited when there is a large set (more than 10) of monitored variables.

Such a computation may be generalized as follows, with N the number of test runs and P the number of monitored variables/sensors, n∈ [symbol] 1, N [symbol] , p∈ [symbol] 1, P [symbol] , and Mₚ. All dissimilarity indexes for the N test runs are calculated in a multivariate way:

Φ=(ϕ₁, . . . , ϕ_{N})=f[Mₚ] [Equation 3]

At the end of this step, a dissimilarity index for each of the monitored variable and each test run is obtained, as shown in Table 1.

Based on such a table that may be stored in the memory means of the computer of the monitoring system, a multivariate difference index may be computed for each test run (1 to N). Examples of such the multivariate difference processing may comprise the Mahalanobis distance, the projection pursuits, the Hotelling T² etc.

The above example uses the RMSE method for computing the dissimilarity indexes, however the Correlation Method may have been used, as well as a composite index combining the RMSE and the Correlation methods.

In a nutshell the Malahanobis distance computes a statistical distance between test runs corrected by the covariance of test runs.

Thus, the greater the distance, the more of sensors are in the atypicality of a test run. On the contrary, the lower the distance, the less of sensors involved in the atypicality of a test runs.

A scan of the dissimilarity indexes may also be used to reveal how many monitored variables are significantly deviating from steady state conditions.

Therefore, the threshold for triggering an alarm or a warning based on the analysis of signals may comprise at least three kinds of information/threshold:
a threshold based on the individual values of the dissimilarity indexes, i.e. when a curve associated with a monitored variable/sensor has a dissimilarity index overpassing a given threshold;
a threshold based on the multivariate difference index, i.e. when the multivariate difference index of a test run overpasses a defined threshold;
a threshold based on the number of monitored variables overpassing a given threshold.
   The 3 types of thresholds may be considered sequentially or concurrently.

Although the method is aimed at detecting an abnormal behavior and not to provide a diagnostic, combining these 3 kinds of thresholds may help characterize the abnormal behavior and be used for a further diagnostic.

Any threshold may be defined beforehand and e.g., stored in a database, either based on prior knowledge of the monitored installation and/or simulation, or advantageously the threshold may be defined dynamically based on the acquired test runs.

For instance, the result of the computations of the dissimilarity indexes are stored in the non-transient memory means of the computer, in a table like Table 1.

The table grows by adding a new line for each test run. From this table, and from time to time, e.g., after a certain number of test runs, a central value M, such as the mean value or the median and a spreading value S, such as a standard deviation or a quartile, of the dissimilarity index may be computed for each column, or over a subset of n test runs out of N test runs. Then a threshold may be defined as M±X·S where X is a scalar usually X>1, and more often X=3, thus defining the threshold dynamically as the number of test runs increases.

The same principle may be applied to the multivariate difference index.

Regarding the type of threshold considering the number of monitored variables overpassing the threshold on dissimilarity indexes, it may be assessed e.g. on a pareto basis like 20% of the monitored variables overpassing the dissimilarity index threshold in a test run.

These are only examples, the person skilled in the art may adapt other types of thresholds, the advantage of the method implementation is that it converts complex unknown monitored variable behaviors into a scalar value, the dissimilarity index, figuring the comparative behavior of the monitored variable compared to an assumed steady state in a statistical sense, and the same applies for comparing test runs even involving a large number of monitored variables.

Because of the easiness of computing the dissimilarity index and the low computing resources to implement this computation, the method may be applied in almost real time over test runs. It may also be applied offline on collected data.

Once one or more thresholds are overpassed, the monitoring system may generate an alarm or a warning. Alarm or warning shall be here considered in a generic sense, and, depending on the monitored installation may consist in emitting a specific sound and/or a light or displaying an information on the display (651) of the monitoring system, or a remote display, or sending a predefined message over a network to selected individuals like a supervisor, or broadcasting such an audio or written message or warning over a wide area, and also depending on the level of the threshold or the set of threshold that have been overpassed.

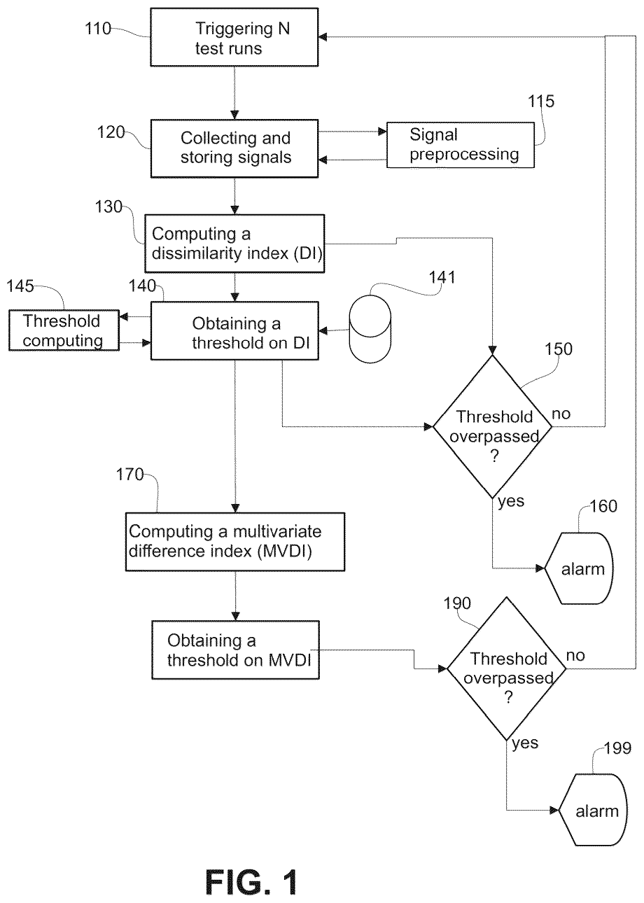

Going back to FIG. 1, according to a first triggering step (110) of the method a series of N test runs with N≥3 is triggered by the monitoring system. Each test run has the same duration and/or corresponds to the same number of data points for the same monitored variable/sensor over the N test runs.

For each test runs, in a collection and storing step (120), the signals of the plurality of sensors are collected at an acquisition frequency or with a given number of datapoints and stored in the non-transient memory means. According to a preferred embodiment the signals are stored in the memory means in real time during the performance of each test runs, however, the system may comprise a buffering memory, for instance on the acquisition board (620), or in the installation itself, like for a satellite, and the storing of the signals in the non-transient memory of the computer may be performed at the end of the N test runs performance or at given time intervals.

According to a specific embodiment the method may comprise a pre-processing step (115) for part or all the signals. This preprocessing step may comprise a retiming and interpolation if required, a Fourier transform, a filtering or combination thereof, without this list being exhaustive. In such a case the preprocessed signal is stored.

After the collecting and storing step (120), the non-transient memory comprises for each monitored variable/sensor N curves of said monitored variable as a function of an acquisition variable. As mentioned before the acquisition variable may be different for each monitored variable.

From this record, in a first computing step (130) a scalar dissimilarity index may be computed for each curve by a comparison with the other curves for the same monitored variable as a function of the same acquisition variable, that is, by a comparison of each curve with the N-1 other curves. Such a comparison in the computing step (130) may be performed by the RMSE method for all or part of the monitored variables, by the Correlation method for all or part of the monitored variables, by a combination of both methods for all or part of the monitored variable, or by any other method providing a scalar dissimilarity index for each curve. At the end of the computation step a table/matrix like Table 1 and comprising for each test run the value of the dissimilarity index for each monitored variable is obtained.

In the step of obtaining a threshold (140) a threshold may be defined for each monitored variable. In a specific embodiment, the threshold may be obtained for part or all the monitored variables from a database (141) configured to be accessed by the computer.

In another embodiment, the threshold is computed statistically over the test runs or a subset of test runs for part or all of the monitored variable in a threshold computing step (145). As mentioned before the two embodiments may be combined.

In a test step (150), the dissimilarity indexes computed during the computing step (130) are compared to the threshold obtained in step 140 and if a dissimilarity index is overpassed on one or more monitored variable the system generates an alarm (160) otherwise, or in parallel, the system may trigger a new series of test runs.

According to an embodiment, based on the records in the non-transient memory the method further comprises a step of computing a multivariate difference index (170).

The multivariate difference index (170) may be computed using, for instance, the Mahalanobis distance, the projection pursuits method or any other relevant projection method that may deliver a scalar multivariate difference index for each test run based on at least two of the monitored variables.

According to this embodiment a threshold may be obtained (180) on the multivariate difference index either from a database or from a statistical calculation over the recorded multivariate difference indexes.

In a second test step (190), the multivariate difference index of each test run is compared with the threshold obtained for the multivariate difference index and if one of the test runs overpasses that threshold an alarm is generated (199).

1. A method for an unsupervised monitoring of an installation comprising at least one sensor measuring a monitored variable of an operation of the installation and delivering a signal proportional to the monitored variable to a monitoring system comprising a computer with a non-transient memory, configured to trigger a test run and to acquire the signal delivered by said at least one sensor during the test run, further comprising a computer program configured to store an acquired signals in the non-transient memory and to process a plurality of signals stored in the non-transient memory, comprising:
triggering a plurality of N test runs, with N being an integer greater than or equal to 3, each test run of the plurality having a same number of datapoints;
collecting and storing in the non-transient memory the signal delivered by said at least one sensor for said each test run as a succession of datapoints, each datapoint corresponding to a level of the monitored variable at a value of an acquisition variable, the succession of datapoints associated with said each test run and said at least one sensor defining a curve to provide a total of N curves;
computing a scalar dissimilarity index for each curve by a comparison with all other N-1 curves of the plurality of N test runs;
obtaining a threshold of the scalar dissimilarity index; and
generating an alarm if the scalar dissimilarity index of a curve associated with any of the plurality of N test runs overpasses the threshold of the scalar dissimilarity index.

2. The method of claim 1, wherein the comparison comprises for said each curve: computing quadratic distances for each datapoint of said each curve relative to N-1 datapoints of the other curves at a same value of the acquisition variable; and computing a sum of the quadratic distances with the other curves for each value of the acquisition variable, the dissimilarity index for said each curve being a root mean square of the distances with the other N-1 curves.

3. The method of claim 1 wherein the comparison comprises computing a scalar correlation coefficient of said each curve with each of the N-1 curves, the dissimilarity index of said each curve being mean value of the N-1 scalar correlation coefficient of said each curve with the N-1 other curves.

4. The method of claim 1, wherein the acquisition variable is selected among time, distance and frequency.

5. The method of claim 1, wherein the monitored variable is selected among, pressure, force, strains, acceleration, speed, distance, voltage, intensity, electrical impedance, power, energy, temperature, flowrate, luminance, chrominance, reflectance, concentration and radioactivity.

6. The method of claim 1, wherein the threshold of the scalar dissimilarity index is obtained from a database accessible by the computer.

7. The method of claim 1, further comprising:
storing the dissimilarity index computed for said each test run in the non-transient memory;
retrieving a subset of n dissimilarity indexes with n≤N from the non-transient memory and computing a central value M and a spreading value S of the scalar dissimilarity index over the subset of n dissimilarity indexes; and
obtaining the threshold of the scalar dissimilarity index by M±X·S with X≥1.

8. The method of claim 7, comprising obtaining multiple threshold levels for different values of X and wherein a different alarm is generated depending on the overpassed threshold level.

9. The method of claim 7 wherein the central value M is a mean value.

10. The method of claim 7, wherein the central value is a median.

11. The method of claim 7, wherein the spreading value is a standard deviation.

12. The method of claim 7, wherein the spreading value is a quartile.

13. The method of claim 1, wherein the installation comprises at least another sensor and further comprising:
for the plurality of N test runs, storing the signal delivered by said at least other sensor for said each test run as a second succession of datapoints, each datapoint of the second succession corresponding to a level of a second monitored variable at a second value of a second acquisition variable, the second succession of datapoints defining a second curve associated with a test run and said at least other sensor for a second total of N curves;
computing a second scalar dissimilarity index for each second curve associated by a comparison with all other N-1 second curves of the plurality of N test runs;
computing a scalar multivariate difference index for said each test run of the plurality of N test runs by a multivariate distance from one test run to another based on the scalar dissimilarity index of the N curves associated with said at least one sensor and the second scalar dissimilarity index of the N second curves associated with said at least other sensor;
obtaining a threshold for the scalar multivariate difference index; and
generating an alarm if the scalar multivariate difference index of any of the plurality of N test runs overpasses the threshold of the scalar multivariate difference index.
